(19) United States
(12) Patent Application Publication
(10) Pub. No.: US 2012/0196088 A1
(43) Pub. Date: Aug. 2, 2012

(54) ARTICLE AND METHOD FOR FORMING LARGE GRAIN POLYCRYSTALLINE SILICON FILMS

(76) Inventors: Prantik Mazumder, Ithaca, NY (US); Wageesha Senaratne, Horseheads, NY (US); Donald A. Wood, Waterloo (BE)

(21) Appl. No.: 13/017,453

(22) Filed: Jan. 31, 2011

(51) Int. Cl. B32B 3/30; B22D 11/041; B29C 39/02

(52) U.S. Cl. 428/156; 264/299; 425/269

(57) ABSTRACT

A templated mold comprises a mold body formed from a mold material. The mold body has at least one major surface with a patterned layer formed from a patterning material disposed over the major surface. The patterned layer defines a high nucleation energy barrier surface and a plurality of nucleation surfaces, such that a contact angle of a molten semiconducting material with the nucleation surfaces is less than a contact angle of the molten semiconducting material with the high nucleation energy barrier surface, and the nucleation surfaces are formed from either the mold material or the patterning material.

### FIELD

The disclosure relates to methods of making an article of semiconducting material and mold configurations for performing such methods, and more particularly to exocasting methods whereby an article of semiconducting material is formed over an external surface of a templated mold.

### BACKGROUND

Semiconducting materials are used in a variety of applications, and may be incorporated, for example, into electronic devices such as photovoltaic devices. Photovoltaic devices convert light radiation into electrical energy through the photovoltaic effect.

The properties of semiconducting materials may depend on a variety of factors, including crystal structure, the concentration and type of intrinsic defects, and the presence and distribution of dopants and other impurities. Within a semiconducting material, the grain size and grain size distribution, for example, can impact the performance of resulting devices. By way of example, the electrical conductivity and thus the overall efficiency of a semiconductor-based device such as a photovoltaic cell will generally improve with larger and more uniform grains.

For silicon-based devices, silicon may be formed using a variety of techniques. Examples include silicon formed as an ingot, sheet or ribbon. The silicon may be supported or unsupported by an underlying substrate. However, conventional methods for making supported and unsupported articles of silicon have a number of shortcomings.

Methods of making unsupported thin semiconducting material sheets, including silicon sheets, may be slow or wasteful of the semiconducting material feedstock. Unsupported single crystalline semiconducting materials can be produced, for example, using Czochralski or Bridgman processes. However, such bulk methods may disadvantageously result in significant kerf loss when the material is cut into thin sheets or wafers. Additional methods by which unsupported polycrystalline semiconducting materials can be produced include electromagnetic casting and direct net-shape sheet growth methods such as ribbon growth processes. However, these techniques tend to be slow and expensive. Polycrystalline silicon ribbon produced using silicon ribbon growth technologies is typically formed at a rate of only about 1-2 cm/min.

Supported semiconducting material sheets may be produced less expensively, but the semiconducting material sheet may be limited by the substrate on which it is formed, and the substrate may have to meet various process and application requirements, which may be conflicting.

Methods for producing unsupported polycrystalline semiconducting materials are disclosed in commonly-owned U.S. patent application Ser. No. 12/466,143, filed May 14, 2009, and commonly-owned U.S. patent application Ser. No. 12/394,608, filed Feb. 27, 2009, the disclosures of which are hereby incorporated by reference. These disclosures relate generally to exocasting methods for forming polycrystalline semiconducting materials wherein a solid layer of semiconducting material is formed over an external surface of a mold that is dipped into a molten semiconducting material

As described herein, the inventors have now discovered additional methods by which supported and unsupported articles of semiconducting materials may be made. The disclosed methods may facilitate formation of exocast semiconducting materials having desirable attributes including increased grain size and controlled grain size distribution while reducing material waste and increasing the rate of production.

### SUMMARY

Properties of a solid layer can be influenced by controlling various aspects of the mold used during exocasting. A templated mold for performing exocasting includes a mold body formed from a mold material having at least one major surface, and a patterned layer formed from a patterning material disposed over the major surface defining a high nucleation energy barrier surface and a plurality of nucleation surfaces. A contact angle of a molten semiconducting material with the nucleation surfaces is less than a contact angle of the molten semiconducting material with the high nucleation energy barrier surface. In embodiments, the nucleation surfaces are formed from either the mold material or the patterning material.

In accordance with various exemplary embodiments, an exocasting method of making a solid layer of a semiconducting material comprises submerging a templated mold into a molten semiconducting material and withdrawing the templated mold from the molten semiconducting material to form a solid layer of semiconducting material over an external surface of the templated mold.

As used herein, the term “semiconducting material” includes materials that may exhibit semiconducting properties, such as, for example, silicon, alloys and compounds of silicon, germanium, alloys and compounds of germanium, gallium arsenide, alloys and compounds of gallium arsenide, and combinations thereof. In various embodiments, the semiconducting material may be pure (such as, for example, intrinsic or i-type silicon) or doped (such as, for example, silicon containing at least one n-type or p-type dopant, such as phosphorous or boron, respectively).

As used herein, the phrases “solid layer of semiconducting material,” “article of semiconducting material,” “exocast article,” and variations thereof include any shape or form of semiconducting material made using the disclosed methods. Examples of such articles may be smooth, textured, flat, curved, bent, angled, dense, porous, symmetric or asymmetric. Articles of semiconducting materials may comprise forms such as, for example, sheets, wafers, or tubes.

The term “mold” means a physical structure having an external surface upon or over which the article of semiconducting material can be formed. Molten or solid semiconducting material that is formed over an external surface of the mold need not physically contact the mold surface, although contact may occur.

The term “templated mold” means a mold having a patterned layer formed over one or more external surfaces of the mold. The patterned layer defines a high nucleation energy barrier surface and a plurality of nucleation surfaces on the mold. The nucleation surfaces may be substantially co-planar with adjacent high nucleation energy barrier surfaces, or the nucleation surfaces may be raised or recessed with respect to adjacent high nucleation energy barrier surfaces.

The term “supported” means that an article of semiconducting material is integral with a mold. The supported article of semiconducting material may optionally remain on the mold for further processing.

The term “unsupported” means that an article of semiconducting material is not integral with a mold. The unsupported article of semiconducting material may be supported by a mold while it is being formed, but then separated from the mold.

The phrase “form a solid layer of a semiconducting material over an external surface of a mold” and variations thereof mean that at least some of the semiconducting material from the molten semiconducting material solidifies on or over an external surface of the mold.

The term “crystalline” means any material comprising a crystal structure, including, for example, single crystal and polycrystalline semiconducting materials.

The term “polycrystalline” includes any material comprised of a plurality of crystal grains. For example, polycrystalline materials may have grain sizes in the range of 0.1 mm to 10 cm, though smaller grain sizes including micro-crystalline and nano-crystalline materials may be formed as well.

The terms “temperature of the molten semiconducting material,” “bulk temperature of the molten semiconducting material,” and variations thereof mean the average temperature of the molten semiconducting material contained within a vessel. Localized temperatures within the molten semiconducting material may vary spatially at any point in time, such as, for example, near melt-vessel or melt-atmosphere boundaries, or in areas of the molten semiconducting material proximate to the mold while the mold is submersed. In various embodiments, the average temperature of the molten semiconducting material is substantially uniform despite any localized temperature variation.

As used herein, the term “undercooling” refers to a process by which a material is cooled below a transformation temperature without obtaining the transformation. The amount of undercooling of a liquid, for example, is a temperature difference between a measured temperature and a solidification temperature of the liquid. The amount of undercooling may be measured in degrees Celsius (° C.) or degrees Fahrenheit (° F.).

As used herein, the term “average submersion time,” unless otherwise indicated, refers to the average time that a mold is submersed in molten semiconducting material. For a mold having length L, and assuming no acceleration or deceleration during submersion and withdrawal, the average submersion time is equal to L/2Vᵢₙ+L/2Vₒᵤₜ+t_{dwell}, where Vᵢₙ and Vₒᵤₜ are the submersion and withdrawal velocities, respectively, and t_{dwell} is an optional dwell time (e.g., hold time) between submersion and withdrawal. In embodiments where the submersion velocity is equal to the withdrawal velocity and the dwell time is zero, the average submersion time is simply equal to L/V. For a mold having a length L, a “first submersion time” corresponding to a leading edge of the mold is equal to L/Vᵢₙ+L/Vₒᵤₜ+t_{dwell}, while a “second submersion time” corresponding to a trailing edge of the mold is equal to t_{dwell}.

Methods of affecting the grain size, grain size distribution and/or morphology of a solid layer formed during an exocasting process are described herein. In the description that follows, certain aspects and embodiments will become evident. It should be understood that the invention, in its broadest sense, could be practiced without having one or more features of these aspects and embodiments. It should be understood also that these aspects and embodiments are merely exemplary and explanatory, and are not restrictive of the invention as claimed.

### BRIEF DESCRIPTION OF DRAWINGS

The following figures, which are described below and which are incorporated in and constitute a part of the specification, illustrate exemplary embodiments and are not to be considered limiting of the scope of the invention. The figures are not necessarily to scale, and certain features and certain views of the figures may be shown exaggerated in scale or in schematic in the interest of clarity and conciseness.

FIGS. 1A-1L illustrate an exemplary exocasting method for making an article of semiconducting material;

FIG. 2 is a graph of solid layer thickness versus submersion time according to one embodiment;

FIG. 3 is a cross-sectional schematic of an example template structure according to on embodiment;

FIG. 4A is schematic of a templated mold according to one embodiment and FIG. 4B is an image of a silicon carbide patterned silica mold;

FIGS. 5A and 5B are plan views of example templated molds showing a high density of nucleation surfaces (FIG. 5A) and a low density of nucleation surfaces (FIG. 5B); and

FIG. 6A-6D are cross-sectional schematics depicting an example process for forming a solid layer of semiconducting material.

### DETAILED DESCRIPTION

In an exocasting process, a solid mold is submersed into and then withdrawn from a volume of molten semiconducting material. Due in large part to heat loss to the mold and the surroundings, a portion of the molten semiconducting material undergoes a liquid-to-solid phase transformation, which results in the formation of a solid layer of the semiconducting material over an external surface of the mold. In the process, the mold acts as both a heat sink and a solid form for the solidification to occur. By controlling various aspects of the process, including the geometry of the mold, attributes of the resulting solid layer including grain size and grain size distribution can be affected.

According to embodiments, a templated mold is provided having both high nucleation energy barrier and low nucleation energy barrier regions. In contrast to a conventional mold, which is substantially homogeneous both structurally and chemically, the templated mold disclosed herein comprises a modulated energy barrier wherein isolated regions having a low energy barrier to nucleation with respect to the molten semiconducting material are formed among a high energy barrier background. Such a templated mold can be used to control the nucleation density and the resulting grain size and grain size distribution in solid layers formed via the exocasting process. In embodiments, nuclei nucleate preferentially at the regions that present a low nucleation energy barrier, which reduce the total number of initial nuclei and, in turn, increase the average grain size within the resulting solid layer.

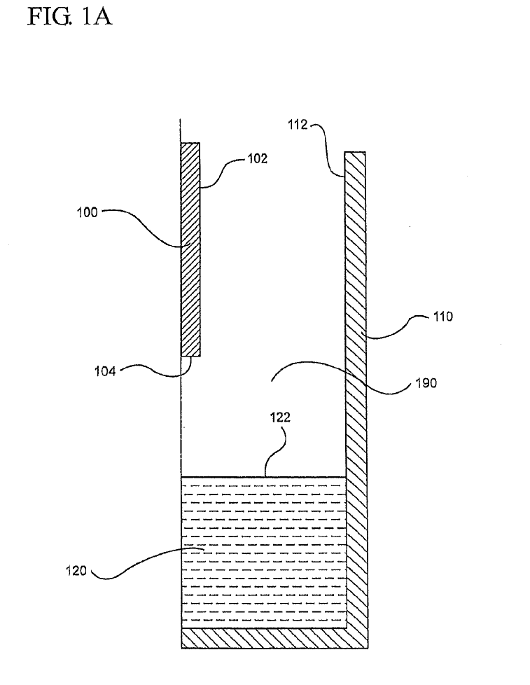

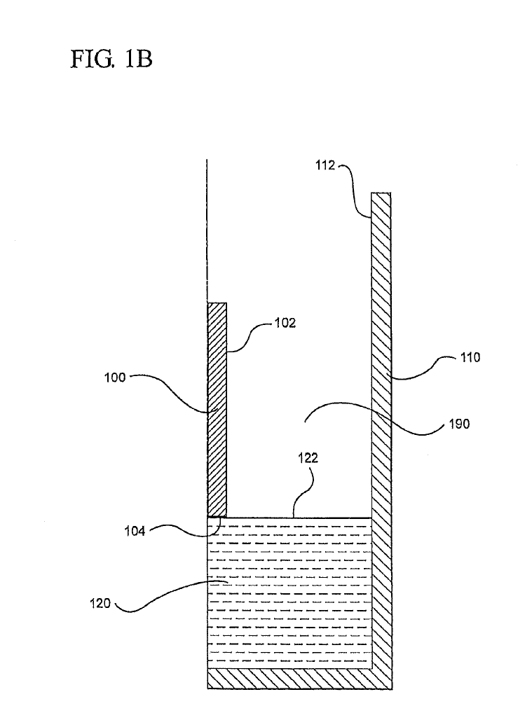

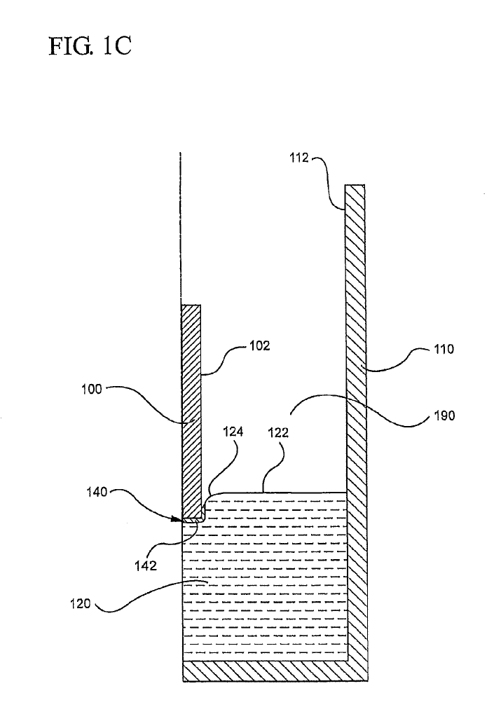

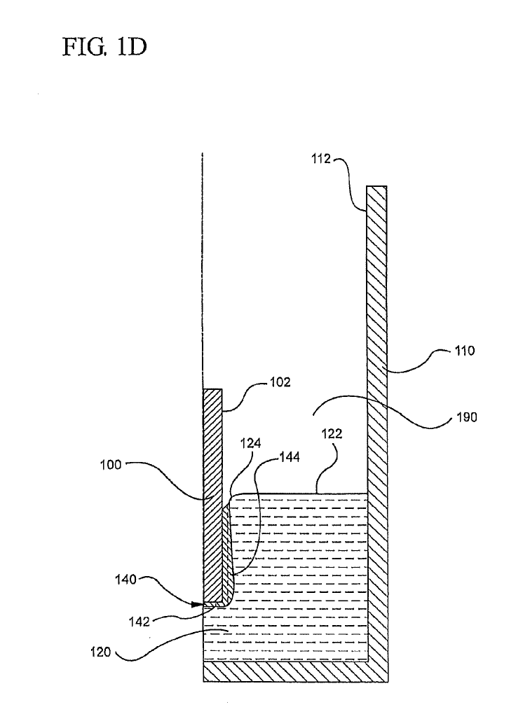

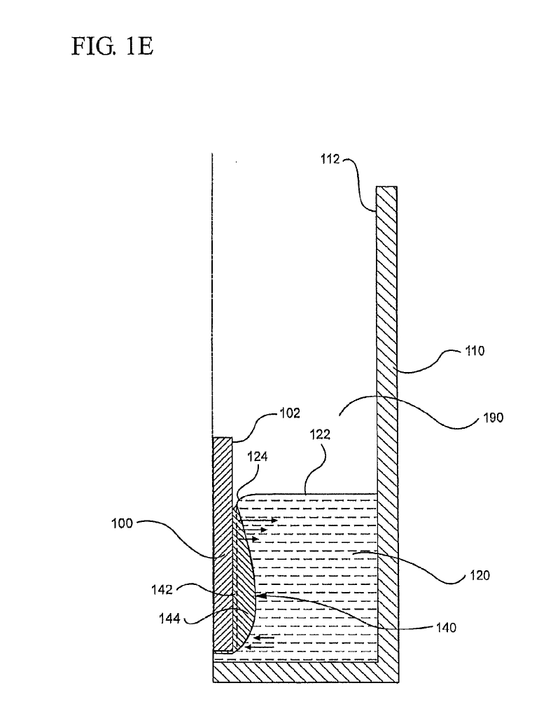

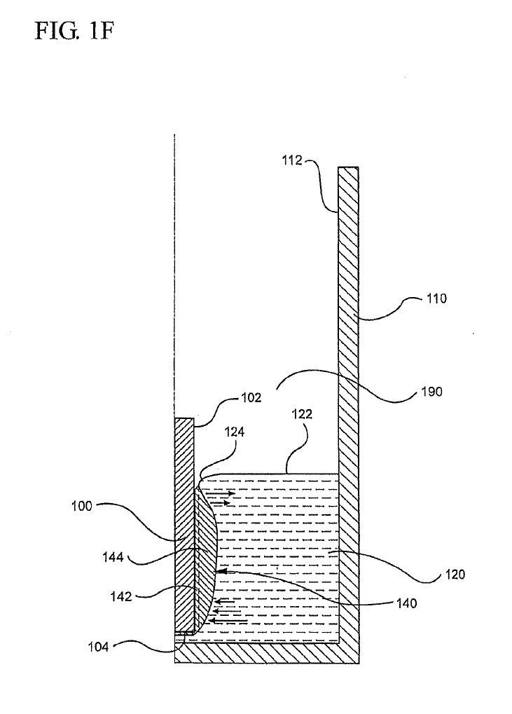

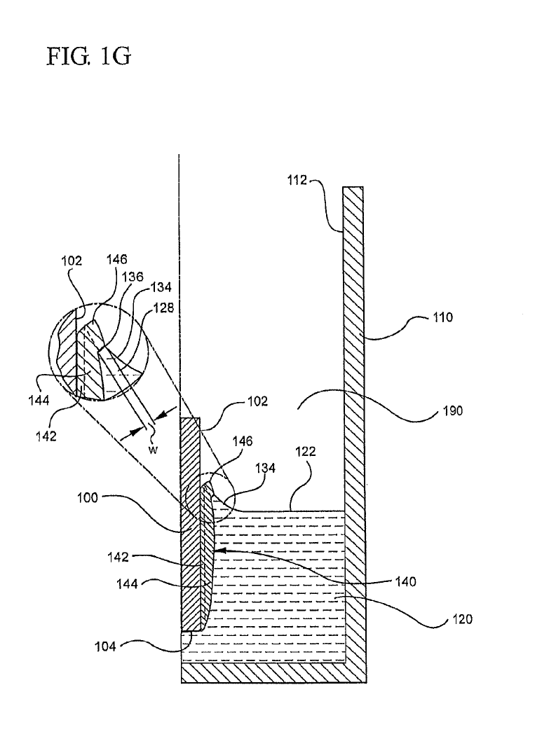

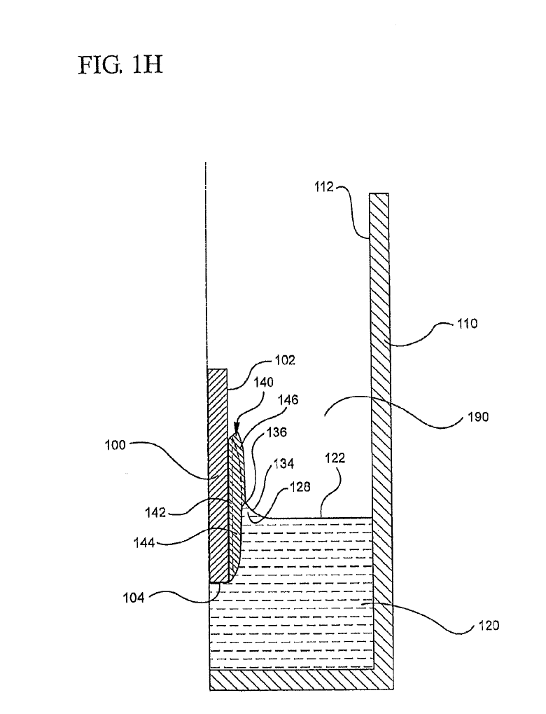

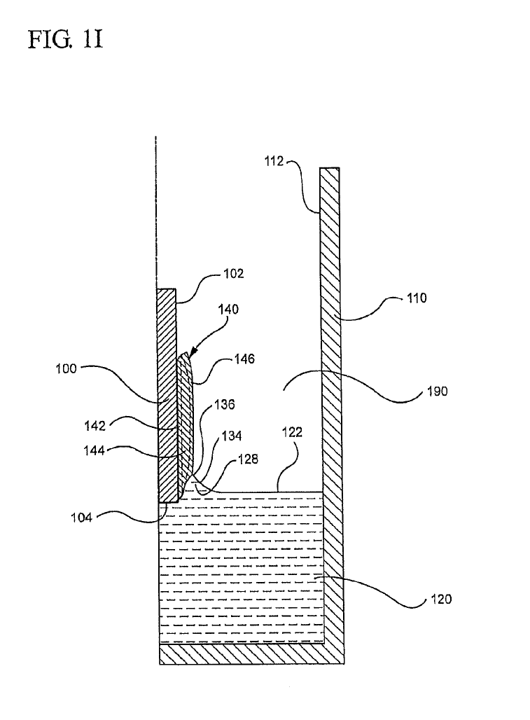

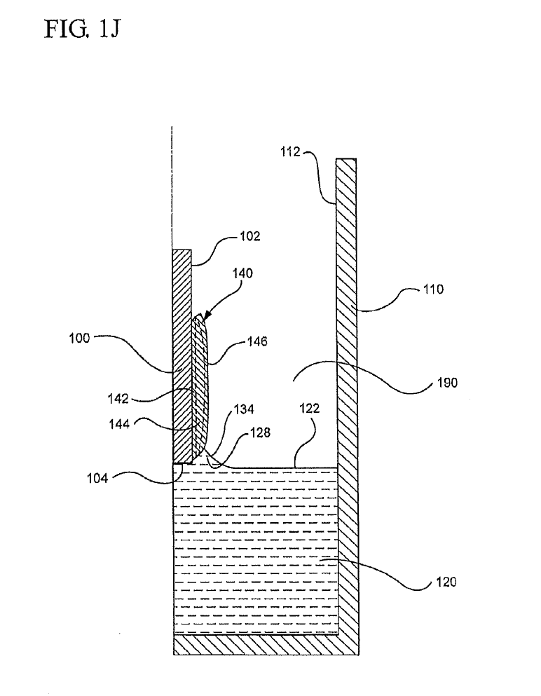

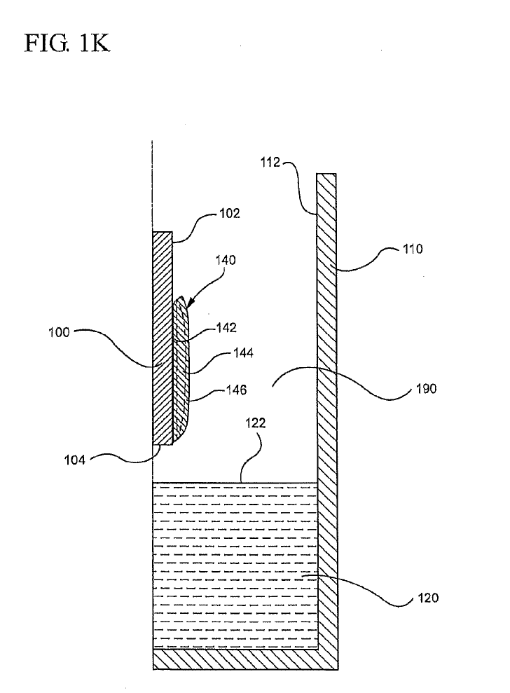

As shown in cross-section in FIG. 1A, solid mold 100 having an external surface 102 is suspended above a vessel 110 containing a molten semiconducting material 120. Mold 100 may be in any form suitable for use in the disclosed methods. For example, mold 100 may be in the form of a monolith or wafer. Mold 100 may comprise a porous or a non-porous body, optionally having one or more porous or non-porous coatings. Mold 100 may comprise one or more flat external surfaces 102 or one or more curved external surfaces. A curved external surface may be convex or concave. As disclosed in further detail below, a patterned layer comprising a patterning material is formed over an external surface of the mold body, which defines a plurality of nucleation surfaces and high nucleation energy barrier surfaces on the mold. The mold and its external surface(s) may be characterized by features including shape, dimension, surface area, surface roughness, etc. One or more of these features may be uniform or non-uniform. It will be understood that the features of the mold 100 and its external surface 102 may affect the properties of resulting exocast article.

It will be appreciated that although mold 100 and external surface 102 are illustrated in two-dimensional cross-section, mold 100 is a three-dimensional body and the solid layer 140 that forms over the external surface 102 of the mold is also a three-dimensional body having a length, a width, and a thickness. As disclosed in additional detail hereinafter, the exocast solid layer 140 is formed during different stages of the exocasting process and comprises solid material formed during at least three stages of solidification.

In embodiments, mold 100 is formed from a material that is compatible with the molten semiconducting material 120. For example, the mold 100 may be formed from a material that does not melt or soften when submersed. As a further example, the mold 100 may be thermally stable and/or chemically inert to the molten semiconducting material 120, and therefore non-reactive or substantially non-reactive with the molten semiconducting material.

The molten semiconducting material 120 may be provided by melting a suitable semiconducting material in vessel 110. Vessel 110 may be made from a high temperature or refractory material chosen from vitreous silica, graphite, and silicon nitride. Alternatively, vessel 110 may be formed from a first high temperature or refractory material and provided with an internal coating of a second high temperature or refractory material where the internal coating is adapted to be in contact with the molten semiconducting material. The semiconducting material may be silicon. In addition to silicon, the molten semiconducting material 120 may be chosen from alloys and compounds of silicon, germanium, alloys and compounds of germanium, gallium arsenide, alloys and compounds of gallium arsenide, and combinations thereof.

The molten semiconducting material may comprise at least one non-semiconducting element that may form a semiconducting alloy or compound. For example, the molten semiconducting material may comprise gallium arsenide (GaAs), aluminum nitride (AlN) or indium phosphide (InP).

According to various embodiments, the molten semiconducting material 120 may be pure or doped. Example dopants, if present, may include boron, phosphorous, or aluminum, and may be present in any suitable concentration, e.g., 1-100 ppm, which may be chosen based on, for example, the desired dopant concentration in the resulting article of semiconducting material.

To form an article of a semiconducting material, mold 100 is at least partially submersed into molten semiconducting material 120 and then withdrawn. During the acts of submersion and withdrawal, the molten semiconducting material 102 solidifies and forms a solid layer 140 of semiconducting material over an external surface 102 of the mold.

Without wishing to be bound by theory, solidification occurs in three principal stages. The exocasting process, including a more detailed description of solidification in Stages I-III, can be understood with reference to FIGS. 1A-1L, which portray a series of sequential schematic illustrations according to various embodiments. The submersion of the mold 100 into molten semiconducting material 120 is illustrated schematically in FIGS. 1A-1F, while withdrawal of the mold 100 from the molten semiconducting material 120 is illustrated schematically in FIGS. 1G-1L.

In one exemplary embodiment, using any suitable heating device or method, mold 100 may be brought to a temperature, T_{M}, and the molten semiconducting material 120 may be brought to a bulk temperature, T_{S}, which is greater than or equal to a melting temperature of the semiconducting material.

At least one heating element (not shown) may be used to heat mold 100, vessel 110 and/or maintain the molten semiconducting material 120 at a desired temperature. Examples of suitable heating elements include resistive or inductive heating elements, infrared (IR) heat sources (e.g., IR lamps), and flame heat sources. An example of an inductive heating element is a radio frequency (RF) induction heating element. RF induction heating may provide a cleaner environment by minimizing the presence of foreign matter in the melt.

The composition of the atmosphere 190 above the molten semiconducting material 120 can be controlled before, during, and after submersion. It is believed that the use of vitreous silica for the mold 100 and/or vessel 110 may lead to oxygen contamination of the article of semiconducting material. Thus, in various embodiments, oxygen contamination may optionally be mitigated or substantially mitigated, by melting the semiconducting material and forming the article in a low-oxygen environment, comprising, for example a dry mixture of hydrogen (e.g., less than 1 ppm water) and an inert gas such as argon, krypton or xenon. A low-oxygen environment may include one or more of hydrogen, helium, argon, or nitrogen. In at least one exemplary embodiment, the atmosphere may be chosen from an Ar/1.0 wt. %H₂ mixture or an Ar/2.5 wt. %H₂ mixture.

Prior to submersion (FIG. 1A) the temperature of the mold T_{M} and the temperature of the molten semiconducting material T_{S} each can be controlled such that T_{M}<T_{S}. In embodiments where the molten semiconducting material comprises silicon, the bulk temperature of the molten silicon, T_{S}, may range from 1414° C. to 1550° C., such as, for example, from 1450° C. to 1490° C., e.g., 1460° C. The initial temperature of the mold, T_{M}, may range from −50° C. to 1450° C. (e.g., from −35° C.-0° C., 20° C.-30° C., 300° C.-500° C., 600-900° C., 1000-1450° C.) prior to submersion in the molten semiconducting material 120.

In embodiments, the initial temperature of the mold may be controlled relative to the temperature of the molten semiconducting material such that the degree of undercooling (i.e., the difference in temperature between the mold and the melt) is minimized. For example, the initial temperature of the mold may be controlled to be within 1000° C. (e.g., within 1000, 900, 800, 700, 600, 500, 400, 300, 200, 100, 50, 20 or 10° C.) of the temperature of the molten semiconducting material. In addition to controlling the mold and molten semiconducting material temperatures, the temperature of the radiant environment, T_{E}, such as a wall 112 of the vessel 110, may also be controlled.

Referring to FIGS. 1B and 1C, as the mold 100 is brought closer to and then submersed into the molten semiconducting material 120, a temperature of the mold, e.g., a temperature of the mold 100 at leading edge 104, will increase due initially to radiative and then conductive and convective heat transfer from the molten semiconducting material 102 to the mold 100.

In embodiments where the mold 100 comprises silica and the molten semiconducting material 120 comprises silicon, a convex meniscus 124 will form at the point of entry of the mold into the molten silicon due to viscous dragging effects and because molten silicon is slightly non-wetting to the silica surface. The contact angle between molten silicon and silica is about 92°.

Initially, the average temperature of the mold 100 will remain less than the temperature of the molten semiconducting material 120. As the mold is submersed further into the molten semiconducting material (FIGS. 1D and 1E), the temperature difference between the mold 100 and the molten semiconducting material 120 will induce a liquid-to-solid phase transformation that results in the formation of a solid layer 140 of the semiconducting material over the external surface 102 of the mold.

The magnitude of the temperature difference between the mold 100 and the molten semiconducting material 120 can affect the microstructure and other properties of the solid layer 140. The temperature gradient between the mold 100 and the molten semiconducting material 120, which may be on the order of 800° C., results in the formation of a Stage I solid layer 142 over the external surface of the mold. The Stage I solid layer may comprise a relatively fine grain size.

In an example embodiment, the mold is submersed into the molten semiconducting material at a rate of V_{y}˜10 cm/sec. Solidification progresses both normal to the plane of the substrate (vₓ), and in a direction parallel to the plane of the substrate (v_{y}). The characteristic solidification speed and the temperature gradient in the normal direction are about 100 microns/sec and about +100° C./cm, while the characteristic solidification speed and temperature gradient in the parallel direction are about 10 cm/sec (i.e., equal to the submersion rate, but in the opposite direction) and −500 to −1000° C./cm.

Without wishing to be bound by theory, it is understood that if the temperature gradient, G (° C./cm), at the interface is negative, the solidification front may be unstable, which can lead to a dendritic morphology. If, on the other hand, the temperature gradient at the interface is positive, the solid-liquid interface may be stable and substantially planar if the solidification rate is below the critical velocity, V_{crit}=αG, where a is a parameter that depends on the material properties.

The calculated V_{crit} for silicon for G˜100° C./cm is about 300 microns/sec. During exocasting, Vₓ is about 100 microns/sec, which means that the normal component of the solidification velocity is within the stable regime (G>0, Vₓ<V_{crit}) and the interface morphology will be planar. However, because the parallel component, V_{y}, falls in the unstable regime (G<0), the interface morphology is dendritic.

The distinctly different temperature gradients in the two orthogonal directions, i.e., positive in the direction normal to the mold and negative in the direction parallel to the mold, promote two distinctly different morphologies (planar and dendritic, respectively). The large negative temperature gradient in the direction parallel to the mold surface leads to the formation and growth of needle-like dendrites having a very high aspect ratio. In addition, the melt just ahead of the tip of the dendrite remains supercooled, which promotes the nucleation of new equiaxed dendrites. Such equiaxed dendrites form ahead of the needle-dendrite tips and become trapped between the needle-dendrites leading to a multi-length scale morphology comprised of long dendritic needles and fine grain equiaxed dendrites in between dendrite arms. Reduction and most preferably elimination of the negative temperature gradient in the direction parallel to the substrate surface would be preferred to create an optimal microstructure.

As shown in FIGS. 1C-1E, as the mold 100 is submersed, molten semiconducting material 120 is first solidified at the leading edge 104 of the mold 100. As the mold is further submersed, a thin Stage I solid layer 142 forms over the exposed external surface 102 of the mold. The growth front of the Stage I solid layer 142 is continuously fed during immersion by molten material from the convex meniscus 124, and the growth direction of the Stage I solid layer 142 is substantially parallel to the relative direction of motion between the mold and the melt (i.e., the growth direction of the Stage I solid layer is substantially parallel to the exposed surface 102 of the mold).

Both homogeneous and heterogeneous nucleation is possible. However, because the energy barrier for heterogeneous nucleation is smaller than that for homogeneous nucleation, it is more probable that nucleation events originate on the mold.

According to embodiments, mold 100 may be rotated or vibrated as it is submersed. In other embodiments, however, the mold is maintained essentially stationary in the transverse dimensions as it is lowered into and raised out of the molten semiconducting material 120. It will be appreciated that in addition to the foregoing, the mold may be held stationary and the vessel containing the molten semiconducting material may be moved (i.e., raised) in order to submerse the mold within the molten semiconducting material. In embodiments, the entire mold may be submersed or substantially all of the mold may be submersed into the molten semiconducting material. For instance, with respect to its length, 90% or more of the mold may be submersed (e.g., 90, 95, 99 or 100%).

As shown in FIGS. 1D-1F, with the mold 100 at least partially submersed in the molten semiconducting material 120, the Stage I solid layer 142 (formed via a growth interface having a growth direction substantially parallel to the external surface of the mold) becomes the template for the formation of a Stage II solid layer, where molten semiconducting material 120 from the melt solidifies at the exposed surface of the Stage I solid layer. Initial formation of a Stage II solid layer 144, which typically occurs at a lower temperature differential than Stage I growth, can increase the thickness of the solid layer 140. Thus, in contrast to Stage I growth, the Stage II solid layer 144 is formed via a growth interface having a growth direction that is substantially perpendicular to the external surface of the mold. Experimental data reveal that the solid layer growth rate during Stage II growth can be on the order of 100 μm/sec.

The microstructure of the solid layer 140 (including the Stage I and Stage II solid layers), in addition to its dependence on the temperature gradient between the mold and the melt, is a function of the rate at which the relative position of the mold 100 is changed with respect to the molten semiconducting material 120. At relatively slow submersion velocities (e.g., on the order of about 1 cm/sec), the temperature differential between the mold 100 and the molten semiconducting material 120 is reduced due to heating of the mold, which generally results in a solid layer 140 having relatively large grains but a relatively small total thickness. On the other hand, at submersion velocities on the order of about 50 cm/sec, the relatively high velocity can disturb the shape of the convex meniscus 124, which can disrupt continuous grain growth and result in a discontinuous solid layer 140 having relatively small crystal grains. In embodiments, the submersion rate can be from about 0.5 to 50 cm/sec, e.g., 1, 2, 5, 10 or 20 cm/sec.

In further embodiments, the submersion rate may be changed (i.e., increased or decreased) during the act of submersion such that the mold is accelerated or decelerated. In one example, during submersion the mold velocity is decreased from about 10 cm/sec to 0 cm/sec at 100 cm/sec^{t over} 7.5 cm of submersed mold.

Quiescent growth of the solid layer during Stage II is a function of the submersion time (i.e., residence time), which, due to the dynamic nature of the exocasting process, will vary spatially over the external surface of the mold 100. The leading edge of the mold will be in contact with the molten semiconducting material for a longer time than the trailing edge of the mold. This leads to an excess residence time for the leading edge equal to L/Vᵢₙ+L/Vₒᵤₜ, compared to the trailing edge, where L is the length of the mold and Vᵢₙ and Vₒᵤₜ are the submersion and withdrawal velocities. Because the leading edge 104 of the mold is the first part of the mold to be submersed, initial growth of the Stage II solid layer 144 can be fastest at or near the leading edge 104 where the temperature differential is the greatest. On the other hand, because the leading edge of the mold is the last part of the mold to be withdrawn, remelting of the Stage II solid layer 144 near the leading edge 104 can decrease the thickness of the solid layer 140 near the leading edge 104.

Mold 100 may be submersed in the molten semiconducting material 120 for a period of time sufficient to allow a solid layer 140 of the semiconducting material to solidify over a surface 102 of the mold 100. The mold 100 may be submersed in the molten semiconducting material 120 for up to 30 seconds or more (e.g., from 0.5 to 30 seconds). By way of a further example, the mold 100 may be submersed for up to 10 seconds (e.g., from 1 to 4 seconds). The submersion time may be varied appropriately based on parameters known to those of skill in the art, such as, for example, the temperatures and heat transfer properties of the system, and the desired properties of the article of semiconducting material.

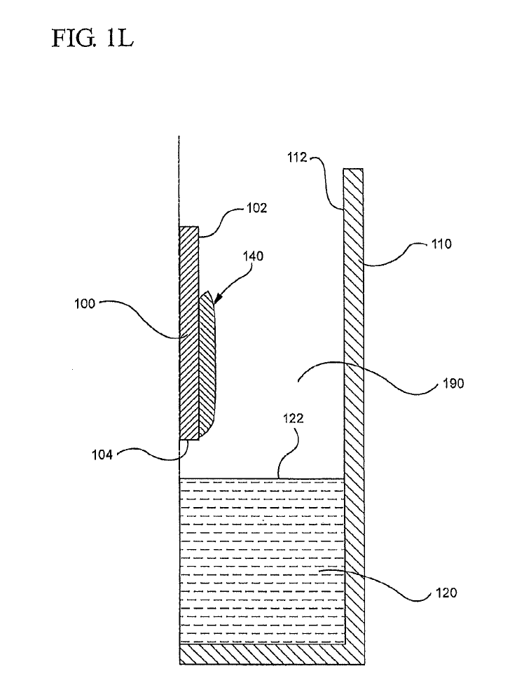

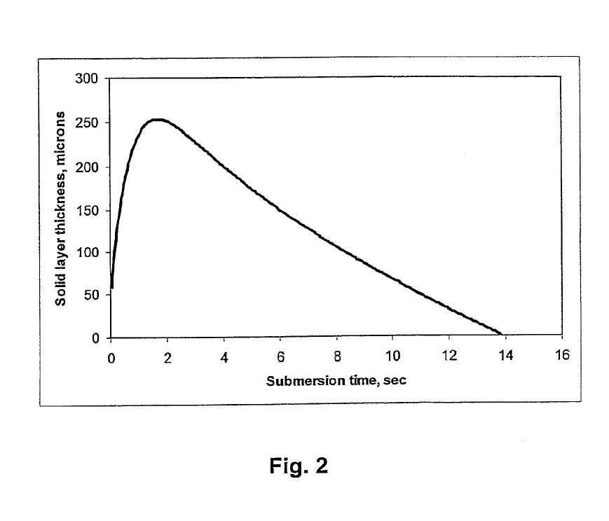

FIG. 2 shows a calculated graph of solid layer thickness measured from the external surface 102 of mold 100 as a function of submersion time. Over an initial time period, the solid layer grows rapidly to a maximum thickness. The thickness then decreases over a subsequent time period. During the initial time period, solidification of the molten semiconducting material commences at the interface between the Stage I solid layer 142 and the melt, and the Stage II layer 144 advances into the molten semiconducting material, which results in a positive rate of growth for the solid layer 140. During the subsequent time period, as the temperature of the mold increases and the heat capacity of the mold is exhausted, remelting of the Stage II solid layer 144 takes place, which results in a negative rate of growth. If the mold were left in the molten semiconducting material 120 indefinitely, eventually the entire solid layer 140 (Stage I and Stage II solid layers) would remelt and dissipate as the mold thermally equilibrates with the molten semiconducting material.

The time where the transition from solidification to remelting takes place is defined as the “transition time.” The thickness of the Stage II solid layer 144 attains its maximum value at the transition time. According to embodiments, the mold can be removed from the molten semiconducting material after a predetermined time that corresponds to the desired thickness of the solid layer.

The dynamics of both the growth and the remelting of the Stage II layer 140 can also be seen with particular reference to FIGS. 1E and 1F. In FIG. 1E, as the mold 102 is near the frill extent of its immersion into the molten semiconducting material 120, the Stage II layer 144 can have a non-uniform thickness. Near the leading edge 104 of mold 100, where the average mold temperature is greatest due to its longer submersion time, the Stage II layer 144 begins to remelt as the direction of the local heat flux is outward from the mold. The remelting causes a local thinning of the Stage II layer 144 near the leading edge 104. At the other end of the mold, which has a lower average mold temperature, the direction of the local heat flux is still into the mold. Absorption of heat by the mold 102 results in growth of the Stage II layer into the melt.

Referring next to FIG. 1F, a shift in the non-uniform thickness of the Stage II layer 144 can be seen over the length of the mold as the mold temperature increases and additional remelting progresses. The small arrows in FIGS. 1E and 1F qualitatively indicate the relative solid layer growth rates at different locations along the interface between the Stage II solid layer 144 and the molten semiconducting material 120.

As illustrated in FIGS. 1A-1F, during submersion, a Stage I solid layer 142 forms over and optionally in direct contact with the exposed surface 102 of the mold 100. In turn, a Stage II solid layer 144 forms over and in direct contact with the Stage I solid layer 142. In embodiments, absent complete remelting of the solid layer 140, the thickness of the Stage I solid layer remains substantially constant during submersion and withdrawal, while the thickness of the Stage II solid layer is dynamic and a function of heat transfer dynamics, which can be controlled, for example, by the local thickness of the mold. A dashed line in FIGS. 1D-1K marks the boundary between the Stage I and Stage II solid layers 142, 144.

Additional aspects of the growth and remelting of the solid layer as a function of the submersion time of the mold are described in commonly-owned U.S. patent application Ser. Nos. 12/466,104 and 12/466,143, each filed May 14, 2009, the disclosures of which being hereby incorporated by reference.

The portion of the exocasting process when the mold 100 is being submersed into the molten semiconducting material 120 is described above and is shown schematically in cross-section in FIGS. 1A-1F. In particular FIG. 1F shows the position of the mold and the formation of solid layer 140 when the mold is at its maximum extent of submersion and the velocity of the mold with respect to the molten semiconducting material 120 is zero. A further portion of the exocasting process (i.e., when the mold 100 is being withdrawn from the molten semiconducting material 120), including the formation of a Stage III solid layer 146 over a surface of the mold, is described next with particular reference to FIGS. 1G-1L.

During withdrawal of the mold, because the exposed solid surface is solidified semiconducting material rather than the original mold material, the wetting dynamics between the solid surface and the melt are likely different from those encountered during submersion. Referring to FIG. 1G, in the example of molten silicon solidifying over a silicon solid layer 140, a dynamic, concave meniscus 134 forms at the solid-liquid-gas triple point. As a result of this dynamic meniscus 134, during withdrawal of the mold from the molten semiconducting material 120, an additional solid layer 146 (Stage III solid layer) forms over the previously-formed solid layers (Stage I and Stage II solid layers). The Stage III solid layer 146 is also referred to herein as the overlayer, and determines the minimum thickness of a solid layer obtained through exocasting.

Although the Stage II solid layer 144 that has formed over the Stage I solid layer 142 will continue to grow or remelt according to the local heat flux dynamics beneath the surface 122 of the molten semiconducting material 120, the Stage III solid layer 146 forms above the equilibrium surface 122 of the molten semiconducting material 120 due to the wetting of the solid layer (e.g., exposed surface of the Stage II solid layer 144) by the molten semiconducting material 120. During withdrawal, a Stage III solid layer growth front 136 is continuously fed by molten material from beneath the dynamic meniscus 134.

In embodiments, a majority of the thickness of the solid layer 140 will be formed during Stage II (i.e., growth that is substantially perpendicular to the mold's external surface). Referring to FIGS. 1G-1J, the dynamic meniscus 134, the Stage II solid layer 144 and the Stage III layer 146 formed during withdrawal define a dynamic volume 128 or “dragged volume” of the melt that is located above the equilibrium surface 122 of the molten semiconducting material 120. The dynamic volume 128, which is approaching solidification as a result of the various heat transfer mechanisms, continuously feeds the Stage III solidification front 136 during withdrawal.

In embodiments, the withdrawal rate can be from about 0.5 to 50 cm/sec, e.g., 1, 2, 5, 10 or 20 cm/sec. Higher withdrawal rates may cause fluid drag that can induce perturbations into the dynamic meniscus, which can be transferred to the Stage III overlayer. In further embodiments, as with the submersion rate, the withdrawal may be changed (i.e., increased or decreased) during the act of withdrawal such that the mold is accelerated or decelerated. In one example, during withdrawal the mold velocity is increased from 0 cm/sec to about 3 cm/sec at 10 cm/sec^{t over} 7.5 cm of submersed mold.

After mold 100 is removed from vessel 110 and sufficiently cooled, the solid layer 140 of semiconducting material may be removed or separated from the mold 100 using, for example, differential expansion and/or mechanical assistance. Alternatively, the solid layer 140 may remain on mold 100 as a supported article of semiconducting material.

Referring again to FIG. 2, because the solid layer thickness versus submersion time curve displays a thickness maximum at the transition time, a solid layer having a particular thickness (i.e., other than the maximum thickness) can be obtained using a submersion time that is less than or greater than the transition time. In the example of FIG. 2, a 200 micron solid layer could be produced using a submersion time of either ˜1.2 seconds or ˜5 seconds.

It will be appreciated that either submersion time would produce a ˜100-200 micron thick solid layer, but that the respective times offer process trade-offs. A process involving a 1.2 second submersion time can be completed more rapidly than a process involving a 5 second submersion time, which can become increasingly important upon scale-up. On the other hand, because the rate of thickness change (i.e., slope of the thickness versus submersion time curve) at about 1.2 seconds is much greater than the rate of thickness change at about 5 seconds, small fluctuations in the more rapid process will lead to greater variability in solid layer thickness.

Applicants have advantageously shown that properties of the resulting solid layer can be affected by controlling the surface properties of the mold 100, and in particular by controlling the local driving forces for nucleation of the molten semiconducting material. As disclosed herein, by taking advantage of a large disparity between the wetting properties of molten semiconducting materials (e.g., molten silicon) on various high temperature ceramics, heterogeneous nucleation can be promoted at distinct sites on the mold, which can result in large grained crystals. During submersion of a templated mold 105, there will be a modulation of the nucleation energy barrier along the external surface 102 of the mold with a plurality of nucleation surfaces offering much lower resistance to nucleation.

According to one embodiment, a mold body 130 having a relatively high overall barrier to nucleation for the molten semiconducting material is patterned with regions having a relatively low barrier to nucleation for the molten semiconducting material. In an example process, a mold body 130 such as a silica mold body is patterned with a layer of silicon carbide. The silicon carbide layer is patterned to provide discrete nucleation surfaces (silicon carbide surfaces) and form a templated mold 105. The templated mold is then submersed into molten silicon.

In this example, nucleation and island growth of silicon from the melt will proceed primarily from the silicon carbide regions. As the templated mold is held in the molten silicon, grains grow from respective silicon carbide regions until their lateral growth is ultimately constrained from impact with neighboring grains.

In the present embodiment, as would be appreciated by a skilled artisan, the dimension and spacing of the patterned nucleation surfaces can impact the resulting solid layer of semiconducting material.

According to a further embodiment, a mold body 130 having a relatively low overall barrier to nucleation of the molten semiconducting material is patterned with a patterned layer 132 that exposes regions having a relatively low barrier to nucleation of the molten semiconducting material.

In an example process, a mold body such as a silicon carbide mold body is patterned with a layer of SiO₂. The SiO₂ layer is patterned to reveal the underlying SiC in selected regions to form a templated mold 105. The templated mold is then submersed into molten silicon.

In this example, nucleation and island growth of silicon from the melt will proceed primarily from the revealed SiC regions. As the templated mold is held in the molten silicon, grains grow from respective SiC regions until their lateral growth is ultimately constrained from impact with neighboring grains.

In the present embodiment, the dimensions and separation between exposed nucleation surfaces can impact the resulting solid layer of semiconducting material. The thickness of the patterned high nucleation energy barrier surface (e.g., SiO₂) can also affect the result. A thicker patterned layer 132 may enable selection of a smaller number of grains before lateral growth can commence. A thicker patterned layer can, due to its thermal mass, have an impact on the local thermal environment, which may decrease the thermal conductivity between the nucleating surfaces and the molten semiconducting material.

In order to minimize nucleation on the high nucleation energy barrier surface, the undercooling of the templated mold can be minimized such that the average temperature between the mold and the melt is less than 500° C. (e.g., less than 500, 450, 400, 350, 300, 350, 200, 150, 100, 50, 25 or 10° C.). For example, the undercooling can be maintained in a range of 10 to 500° C.

The respective high and low barrier regions can have disparate wetting characteristics with the molten semiconductor material, where the regions having a high barrier to nucleation are characterized by a large contact angle (i.e., poor wetting) with the molten semiconducting material, and the regions having a low barrier to nucleation are characterized by a small contact angle (i.e., good wetting) with the molten semiconducting material. By way of example, the contact angle of molten silicon with fused silica is about 92°, while the contact angle of molten silicon with silicon carbide (SiC) is about 38°. Heterogeneous nucleation is favored thermodynamically and kinetically at smaller contact angles. The larger the difference between the contact angles, the more efficient the preferential nucleation on the patterned sites. By providing a discrete number of nucleation surfaces, a relatively low number density of nuclei can be formed during the exocasting process, resulting in a larger grain size for each nuclei.

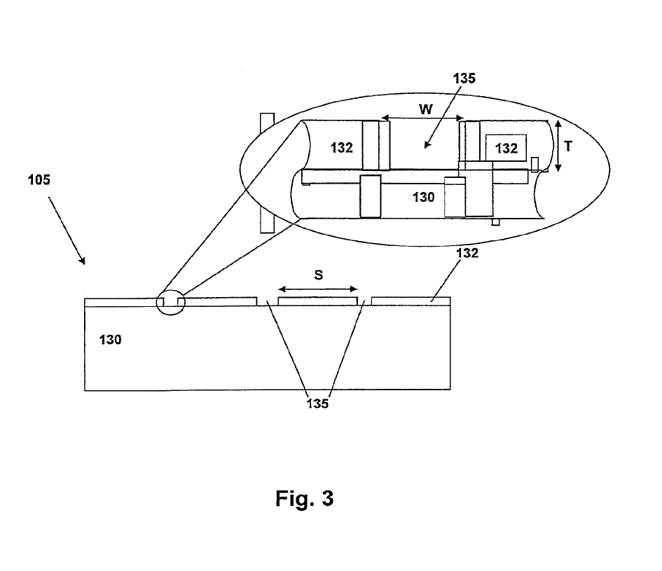

An example of a templated mold comprising an array of sites presenting a low nucleation barrier is shown in FIG. 3. Templated mold 105 has a mold body 130 formed of silicon carbide and a patterned layer 132 formed on or over the mold body. In the illustrated embodiment, one of the external surfaces of the mold body is patterned with a high nucleation energy barrier surface (e.g., silica) to form a two-dimensional array of nucleation surfaces 135. The high nucleation energy barrier surfaces have a lateral dimension S, and the nucleation surfaces 135 have a lateral dimension W.

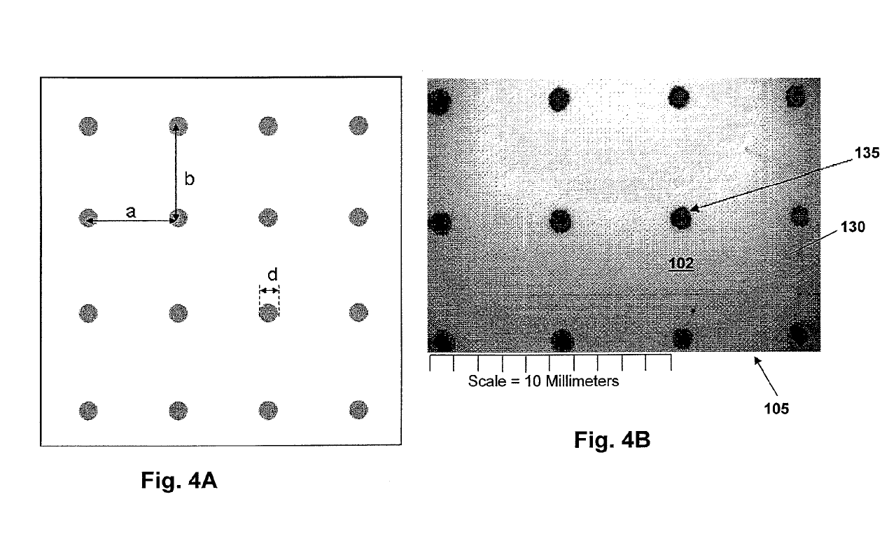

It will be appreciated that an alternative embodiment comprising a plurality of nucleation surfaces (e.g., SiC) formed over a mold body that comprises a high nucleation energy barrier surface with respect to the molten semiconducting material can be formed merely by interchanging the materials in the FIG. 3 embodiment. A plan view of an example array of silicon carbide nucleation surfaces formed over an external surface of a mold is shown in FIG. 4A. In the illustrated embodiment, each silicon carbide island has a diameter d. The plurality of nucleation surfaces are configured in an array defined by vectors a and b.

A patterned layer 132 can be provided over one or both major external surfaces of the mold body 130. The mold body and patterned layer can independently be formed from one or more refractory materials such as fused silica, graphite, silicon carbide, silicon nitride, aluminum nitride, aluminum oxide, lanthanum hexaboride, yttrium oxide, zirconium oxide, boron nitride, and silicon oxide. In an embodiment, the mold body 130 may be made of vitreous silicon dioxide or quartz, and the patterned layer may be made of silicon carbide.

Potential mold body and patterning materials are summarized in Table 1 together with their respective contact angles to molten silicon. As can be seen, BN, SiO₂ and ZrO₂ have the highest contact angles, while SiC has the lowest contact angle. Hence, the templating of BN, SiO₂ or ZrO₂ mold bodies with a SiC patterned layer (or the templating of a SiC mold body with a patterned layer of BN, SiO₂ or ZrO₂) offers the largest driving force for preferential nucleation. In embodiments, the layer that forms the nucleation surfaces may be reactive with the molten semiconducting material, which the reactivity can result in a lower nucleation barrier.

TABLE 1
Mold and Patterning Materials and
Contact Angles with Molten Silicon

| Material | Contact Angle (degrees) |
|---|---|
| AlN | 57 |
| Al₂O₃ | 80 |
| BN | 95 |
| LaB₆ | 52 |
| SiC | 38 |
| Si₃N₄ | 50 |
| SiO₂ | 92 |
| Y₂O₃ | 63 |
| ZrO₂ | 90 |

In embodiments, the templated mold can have a total thickness ranging from about 0.1 to 100 mm (e.g., 0.1, 0.2, 0.5, 1, 2, 5, 10, 20, 50 or 100 mm). A length and width of the mold can independently range from about 1 cm to 100 cm or more (e.g., 1, 2, 5, 10, 50 or 100 cm). A thickness of the patterned layer can range from 10 nm to 2 microns (e.g., 10, 20, 50, 100, 200, 500, 1000 or 2000 nm).

In the alternate embodiments where the patterned layer either forms the nucleation surfaces, or the patterned layer partially masks a mold body that forms the nucleation surfaces, a skilled artisan can select values for both the dimensions of the nucleation surfaces/openings in the patterned layer as well as their spatial arrangement, which may be uniform or non-uniform over the mold, in order to provide a desired nucleation density and resulting average grain size and grain size distribution within the solid layer.

The nucleation surfaces/openings in the patterned layer can have any desired shape (e.g., circle, oval, square, rectangle, etc.) and the characteristic dimension (e.g., length, width, diameter) can range from 0.01 to 10 mm (e.g., 0.1, 0.2, 0.5, 1, 2, 5, or 10 mm). An area of an individual nucleation surface/opening in the patterned layer can range from 0.001 to 100 mm^{2.}

The nucleation surfaces/openings in the patterned layer may be arranged in a regular array or randomly over an external surface of the mold. Spacing between neighboring nucleation surfaces/openings can range from about 1 mm to 50 mm (e.g., 1, 2, 5, 10, 20 or 50 mm). A total area of the nucleation surfaces/openings can range from about 1% to 10% of a total area of the external surface.

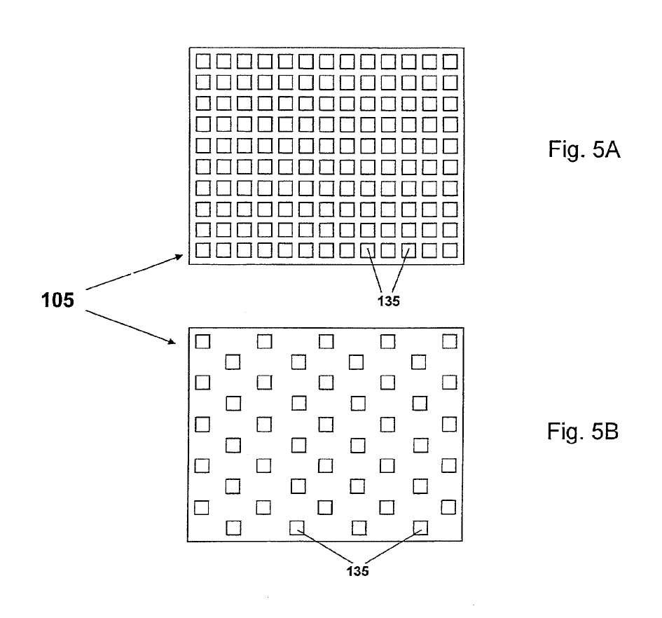

Examples of different arrays are illustrated schematically in FIGS. 5A and 5B, which show template molds 105 comprising a high density of nucleation surfaces 135 and a low density of nucleation surfaces 135, respectively.

The patterned layer can be formed using a variety of techniques such as, for example, vacuum techniques (PVD, PECVD), or by direct application from a liquid source, followed by curing at an appropriate temperature. The openings through the patterned layer can be formed by laser ablation, or by photolithography and etch. It may also be possible to deposit a layer having openings formed in situ, for example, due to porosity inherent to the as deposited layer.

In one approach, a patterned layer can be formed by depositing and patterning (or selectively depositing) a precursor material on the mold body 130, and then reacting the precursor material to form the patterned layer 132. In an alternative approach, the material that forms the patterned layer can be deposited directly over the mold body 130. As with the precursor approach, the material used to form the patterned layer can be blanket deposited and patterned or selectively deposited.

In an example embodiment, patterned regions of silicon carbide can be formed over a fused silica mold by optionally first treating an external surface of the mold with fluorosilane, and then printing a polycarbosilane solution over the optionally treated mold followed by drying and carbothermal reduction to form the silicon carbide pattern. The optional pre-treatment with fluorosilane, can be used to alter the hydrophobicity of the external surface. By choosing the appropriate polycarbosilane precursor and carbothermal reduction conditions, the properties (e.g., crystalline phase, density, porosity, etc.) of the resulting silicon carbide can be controlled. The resulting silicon carbide can porous or dense, amorphous or crystalline, and may comprise a cubic or hexagonal crystal structure.

In a further example embodiment, a dispersion comprising silicon carbide particles can be patterned onto a fused silica mold followed by calcination to form a patterned array of silicon carbide. The dispersion can comprise an optional binder. The binder, if used, can promote inter-adhesion of the SiC particles during printing as well as adhesion of the particles to the mold during calcination.

In addition to the foregoing printing approaches, in other example approaches, vapor or aerosol based deposition, ink-jet printing, nano/micro contact printing, dip pen lithography or spray coating can be used to form the patterned layer.

Liquid silicon carbide precursors such as SMP-10 and CVD-4000 (Starfire Systems, Schenectady, N.Y.) can be used neat or diluted in an organic solvent to form a patterned layer. SMP-10 can be used to form amorphous or beta SiC at temperatures ranging from 850-1700° C., while CVD-4000, which has a basic structure of —[SiH₂—CH₂]ₙ—, can be used to form a SiC layer by vapor deposition at relatively low temperatures (˜600° C.). Further heat treatment after deposition (e.g., 1100-1300° C.) can promote the formation of larger SiC crystal grains.

Low molecular weight polycarbosilanes such as poly(methylsilylene)methylene and higher molecular weight polysilanes such as poly(phenylmethyl)silane copolymer (50% dimethylsilane, 50% phenylmethylsilane) (Gelest, Inc., Bristol, Pa.) can also be used as SiC precursors.

DSC/TGA was used to determine weight loss and composition changes associated with temperature under N₂ or Ar atmosphere for various precursor materials. From the liquid SiC precursors, SMP-10 has good ceramic yield with about 12% weight loss by 500° C. and forms amorphous, beta-SiC or alpha-SiC depending on the process temperature. CVD-4000 has slightly greater than 85% weight loss by 200° C., while high molecular weight polysilanes show slightly greater than 75% weight loss by 400° C.

Wide angle XRD patterns were obtained for different silicon molds after patterning via thermal curing followed by carbothermal reduction at 1300° C. in argon. SMP-10 and CVD-4000 derived layers exhibit reflections consistent with cubic SiC (moissanite 3C) while the poly(phenylmethyl) silane produces hexagonal SiC (moissanite 6H). The XRD show no residual amorphous carbon or silica for SMP-10, but CVD-4000 show a graphitic peak at 26.5 Å. Poly(phenylmethyl) silane shows a broad band with low intensity around 25 Å and 40 Å, which may indicate the presence of amorphous carbon or silica.

Preliminary experiments were carried out by dispensing 0.1-5 μl droplets of SMP-10, CVD-4000 (non diluted) and 1-5 μl of 5 wt. % poly(phenylmethyl)silane in THF onto silica molds. The droplets were let to dry at room temperature. Excess liquid was removed from the droplet to prevent spreading when heating to high temperature. The patterned molds were then treated using a thermal curing step followed by a carbothermal reduction step (1300° C.) in inert atmosphere (N₂ or Ar). An example of a silicon carbide templated silica mold is shown in FIG. 4B. The templated mold 105 includes a plurality of nucleation surface 135 formed over an external surface 102 of mold body 130.

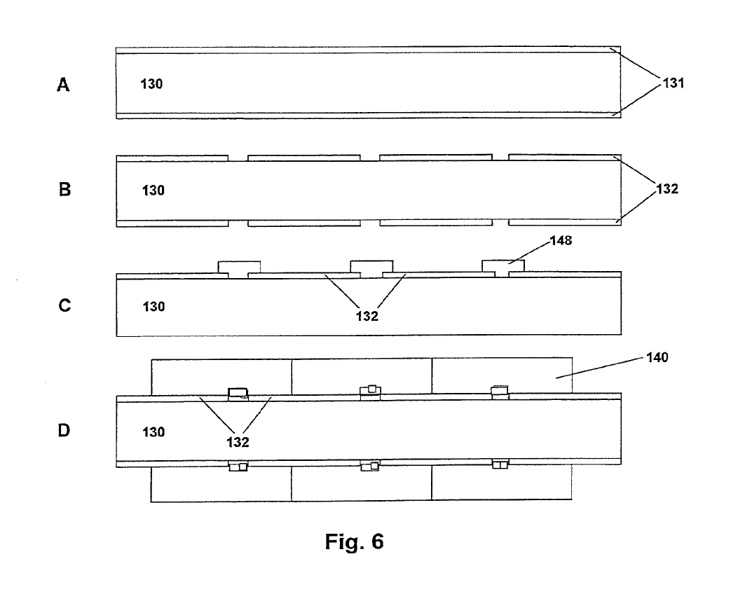

An example exocasting process incorporating a templated mold according to one example embodiment is illustrated in FIG. 6. In step A, a 10-50 nm thick silica layer 131 is formed over a silicon carbide mold. In step B, the silica layer is patterned to reveal the underlying silicon carbide is selected regions to form a templated mold. As depicted in step C, the templated mold 105 is submersed into a molten semiconducting material where nucleation and growth of discrete islands 148 proceeds from the revealed silicon carbide regions. Lateral growth of the solid layer 140 can be constrained when adjacent silicon grains coincide. As the templated mold 105 is held in the molten semiconducting material 120, the silicon grains can grow and eventually coalesce to form a solid layer of semiconducting material over an external surface of the mold. As illustrated in step D, the patterning and templated nucleation and growth can occur over both major surfaces of the mold.

The disclosed methods can be used to produce articles of semiconducting material having one or more desired attributes related to, for example, total thickness, thickness variability, average grain size, grain size distribution, impurity content and/or surface roughness. Such articles, such as, for example, silicon sheets, may be used to for electronic devices such as photovoltaic devices. By way of example, an as-formed silicon sheet may have areal dimensions of about 156 mm×156 mm, a thickness in a range of 100 μm to 400 μm, and a substantial number of grains larger than 1 mm. In embodiments, a total thickness of the solid layer is 150, 200, 250, 300, 350 or 400 μm. In further embodiments, a total thickness of the solid layer is less than 400 μm (e.g., less than 350, 300, 250, 200 or 150 μm).

One advantage of the disclosed method includes the ability to minimize the total thickness variability (TTV) due to residence time variability over an areal dimension of the solid layer. A further advantage is the ability to minimize the total thickness variability due to fluctuations of process parameters such as mold and melt temperatures. A still further advantage is the ability to control the average grain and/or the grain size distribution within the solid layer.

Total thickness variability means the normalized maximum difference in thickness between the thickest point and the thinnest point within a sampling area of a solid layer. The total thickness variability, Try, is equal to (tₘₐₓ-tₘᵢₙ)/t_{target}, where tₘₐₓ and tₘᵢₙ are the maximum and minimum thicknesses within the sampling area and t_{target} is the target thickness. The sampling area may be defined as the whole or a portion of the solid layer. In an embodiment, the total thickness variability of a solid layer is less than 30% (e.g., less than 10% or less than 5%). In processes involving the formation of more than one solid layer, a thickness dispersion is defined as the standard deviation of the ratio of average solid layer thickness to target thickness.

Unless otherwise indicated, all numbers used in the specification and claims are to be understood as being modified in all instances by the term “about,” whether or not so stated. It should also be understood that the precise numerical values used in the specification and claims form additional embodiments. Efforts have been made to ensure the accuracy of the numerical values disclosed herein. Any measured numerical value, however, can inherently contain certain errors resulting from the standard deviation found in its associated measuring technique.

It is noted that, as used in this specification and the appended claims, the singular forms “a,” “an,” and “the,” include plural referents unless expressly and unequivocally limited to one referent, and vice versa. Thus, by way of example only, reference to “a solid layer” can refer to one or more layers, and reference to “a semiconducting material” can refer to one or more semiconducting materials. As used herein, the term “includes” and its grammatical variants are intended to be non-limiting, such that recitation of items in a list is not to the exclusion of other like items that can be substituted or added to the listed items.

It will be apparent to those skilled in the art that various modifications and variation can be made to the programs and methods of the present disclosure without departing from the scope its teachings. Other embodiments of the disclosure will be apparent to those skilled in the art from consideration of the specification and practice of the teachings disclosed herein. It is intended that the embodiments described in the specification be considered as exemplary only.

We claim:

1. A templated mold comprising:
a mold body formed from a mold material, the mold body having at least one major surface, and
a patterned layer formed from a patterning material disposed over the major surface and defining a high nucleation energy barrier surface and a plurality of nucleation surfaces, wherein
a contact angle of a molten semiconducting material at the nucleation surfaces is less than a contact angle of the molten semiconducting material at the high nucleation energy barrier surface and the nucleation surfaces are formed from either the mold material or the patterning material.

2. The templated mold according to claim 1, wherein the mold material is different than the patterning material and the mold material and the patterning material are independently selected from the group consisting of fused silica, graphite, silicon carbide, silicon nitride, aluminum nitride, aluminum oxide, lanthanum hexaboride, yttrium oxide, zirconium oxide, boron nitride, and silicon oxide.

3. The templated mold according to claim 1, wherein the mold material is selected from the group consisting of zirconium oxide, boron nitride and silicon oxide and the patterning material is silicon carbide.

4. The templated mold according to claim 1, wherein the mold body is fully dense.

5. The templated mold according to claim 1, wherein the mold body is porous.

6. The templated mold according to claim 1, wherein a total area of the nucleation surfaces is less than a total area of the high nucleation energy barrier surface.

7. The templated mold according to claim 1, wherein a total area of the nucleation surfaces is from about 1% to 10% of a total area of the major surface.

8. The templated mold according to claim 1, wherein an individual area of the nucleation surfaces ranges from 0.001 to 10 mm².

9. The templated mold according to claim 1, wherein the mold material forms the nucleation surfaces and the patterning material forms the high nucleation energy barrier surface.

10. The templated mold according to claim 1, wherein the mold material forms the high nucleation energy barrier surface and the patterning material forms the nucleation surfaces.

11. The templated mold according to claim 1, wherein the patterning material is substantially crystalline.

12. The templated mold according to claim 1, wherein the patterning material is substantially amorphous.

13. The templated mold according to claim 1, wherein the nucleation surfaces are formed as an array over the major surface.

14. A method of forming a solid layer of semiconducting material, comprising:
submerging a templated mold into a molten semiconducting material and withdrawing the templated mold from the molten semiconducting material to form a solid layer of semiconducting material over an external surface of the templated mold, wherein the templated mold comprises
a mold body formed from a mold material, the mold body having at least one major surface, and
a patterned layer formed from a patterning material disposed over the major surface and defining a high nucleation energy barrier surface and a plurality of nucleation surfaces, such that
a contact angle of the molten semiconducting material at the nucleation surfaces is less than a contact angle of the molten semiconducting material at the high nucleation energy barrier surface and the nucleation surfaces are formed from either the mold material or the patterning material.

15. The method according to claim 14, wherein the mold is submersed and withdrawn at a substantially constant velocity.

16. The method according to claim 14, wherein an initial temperature of the mold ranges from about −50° C. to 1400° C.

17. The method according to claim 14, wherein a difference between a temperature of the molten semiconducting material and the templated mold is less than 500° C.

18. The method according to claim 14, wherein a rate of submersion is from about 0.5 to 50 cm/sec.

19. The method according to claim 14, wherein a rate of withdrawal is from about 0.5 to 50 cm/sec.

20. The method according to claim 14, wherein a rate of submersion is substantially equal to a rate of withdrawal.

21. A solid layer of semiconducting material made according to the method of claim 14.
